(19) United States
(12) Patent Application Publication
(10) Pub. No.: US 2025/0321176 A1
(43) Pub. Date: Oct. 16, 2025

(54) IMPROVED SYSTEM FOR THE MEASUREMENT OF THE ERYTHROCYTE SEDIMENTATION RATE AND RELATED METHOD

(71) Applicant: DIESSE DIAGNOSTICA SENESE S.P.A., Milano (IT)

(72) Inventors: Leonardo BOCCHI, Firenze (IT); Michele MELONI, Monteriggioni (SI) (IT); Barbara FERRISI, Monteriggioni (SI) (IT)

(73) Assignee: DIESSE DIAGNOSTICA SENESE S.P.A., Milano (IT)

(21) Appl. No.: 18/868,919

(22) PCT Filed: Jun. 22, 2023
(86) PCT No.: PCT/EP2023/067027

§ 371 Date: Nov. 25, 2024

(30) Foreign Application Priority Data
Jun. 28, 2022 (IT) 102022000013600

(51) Int. Cl. G01N 15/05; G01N 15/01

(52) U.S. Cl. CPC G01N 15/05; G01N 2015/012; G01N 2015/055

(57) ABSTRACT

A system for measuring erythrocyte sedimentation rates in blood samples is described having a support for a tube containing a blood sample, an agitating element to agitate the tube, a detection unit to perform an optical measurement on the blood sample, moving means to cause movement between the detection unit and the tube during the optical measurement, and a processing unit to process signals from the detection unit. The processing unit creates a reading curve corresponding to the absorption of radiation emitted by the detection unit as a function of the relative movement between the detection unit and the tube and defines an ideal trapezoidal curve to approximate the reading curve to generate an optimized ideal curve, and generate a value indicative of the erythrocyte sedimentation rate of the blood sample in the tube. The system also includes output means to output measurement results based on the generated values.

### FIELD OF APPLICATION

The present invention refers to a system, and a related method, for the analysis of biological samples, in particular for the measurement of the erythrocyte sedimentation rate in blood samples. The following description refers to this field of application with the sole purpose of simplifying the exposition thereof.

### PRIOR ART

The measurement of the erythrocyte sedimentation rate (ESR) is a very common laboratory test for quickly identifying inflammatory processes. Specifically, the rate, with which the erythrocytes in a blood sample settle at the bottom of a tube, is evaluated.

As well known in this technical field, the reference calculation method of the ESR is the Westergreen method, which provides placing the blood to be analyzed diluted with sodium citrate in a graduated tube and measuring the sediment formed after one hour. Said calculation method therefore provides using dedicated tubes and predetermined timings.

There are apparatuses which are able to measure the ESR also on standard tubes (for example the normal blood count tubes), wherein, by optical absorption measurements on the blood sample in the tube, it is possible to obtain measurement values in line with the reference values of the aforementioned Westergreen method. In this case, the measurement is carried out in a relatively short time, for example the blood samples are allowed to stabilize for around twenty minutes before the last reading is carried out.

In apparatuses of the aforementioned type, it is essential to develop optimal calculation procedures for analyzing the optical absorption by the blood sample and to obtain, by said procedures, all the desired parameters for the evaluation of the ESR. In particular, it is very important to be able to quickly obtain measurement values in line with the reference standard, which the current calculation methods are often not able to guarantee.

The technical problem of the present invention is to devise a system, and a related method, which has structural and functional features that are able to overcome the limits and drawbacks complained with regard to the prior art and which, in particular, guarantees a very high degree in reliability and precision of the measurement of the erythrocyte sedimentation rate, while simultaneously allowing to maintain a suitable analysis rate.

### SUMMARY OF THE INVENTION

The solution idea underlying the present invention is to develop a system arranged for measuring the erythrocyte sedimentation rate (ESR) on blood samples in tubes (also blood count standard tubes) by optical measurements, in particular measurements of radiation absorption by the blood sample, wherein the results of the optical absorption measurements are processed by an innovative calculation procedure based on the analysis of the sedimentation, in particular wherein the experimental reading curves obtained by the aforementioned optical absorption measurements are approximated with theoretic curves of the trapezoidal type which suitably describe the sedimentation process. Thereby, by optimizing the theoretic curve of the trapezoidal type, it is possible to obtain, in a very accurate and quick manner, the parameters which allow the estimation of the ESR.

Based on said solution idea, the aforementioned technical problem is solved by a system for the measurement of the erythrocyte sedimentation rate in blood samples, comprising a support for at least one tube containing a blood sample to be analyzed, an agitating element configured to agitate the tube, at least one detection unit configured to perform at least one optical measurement (in particular an optical absorption measurement) on the blood sample in the tube, moving means configured to cause a relative movement between the detection unit and the tube during the optical measurement, so as to irradiate said tube in different portions thereof, a processing unit adapted to process signals from the detection unit, wherein, based on said signals, the processing unit is configured for creating a reading curve corresponding to the absorption of radiation emitted by the detection unit as a function of the relative movement between said detection unit and the tube for defining, based on said reading curve, an ideal curve of the trapezoidal type adapted to approximate said reading curve, for performing a procedure of optimization of said ideal curve, thereby generating an optimized ideal curve, and for generating, based on said optimization procedure, at least one value indicative of the erythrocyte sedimentation rate of the blood sample in the tube, for example output values of the fit algorithm which can be then converted in a ESR value.

More in particular, the invention comprises the following additional and optional features, taken individually or in combination if necessary.

According to an aspect of the present invention, the system can further comprise output means configured to output measurement results based on the generated values (obviously said generated values can already correspond to the shown measurement results or can be suitably processed by the central unit by known formulas or conversions so as to then output the desired results, as cited above). For example, the ESR value can be shown as the output result, but this is not strictly necessary and other results connected to the performed calculation can be also shown, possibly also accompanying the ESR.

According to an aspect of the present invention, the processing unit can be configured to perform the optimization of the ideal curve by least-squares minimization.

According to an aspect of the present invention, the processing unit can be configured to carry out the optimization procedure according to the Levenberg-Marquardt algorithm, wherein the minimized amount is calculated according to the following expression:

$${\sum }_{i} {( {L}_{i} - {T}_{i} )}^{2} / {w}_{i}$$

wherein Lᵢ represents the reading curve which comprises a number of discrete points, Tᵢ represents the ideal curve which comprises a number of discrete points (in particular in a number equal to the number of points of the reading curve), and wᵢ is a weight associated with each point.

According to an aspect of the present invention, the weight wᵢ can be calculated according to the following expression:

$${w}_{i} = {p}_{2} + ( 1 - {p}_{2} ) * ( {L}_{i} - {y}_{2} ) / ( {y}_{1} - {y}_{2} ) + ε$$

wherein p₂ is a parameter adapted to define the weight of the single points of the reading curve, and ε is a correction factor, and wherein p₂ is a parameter which is stored in a memory unit of the processing unit at a default value and which can be modified to improve the optimization of the curve.

According to an aspect of the present invention, the processing unit can be configured to define the ideal curve of the trapezoidal type to be optimized by creating, according to a Cartesian reference system, a parameter vector comprising at least two ordinate values apt to identify the two parallel bases of the trapezoid, and at least four abscissa values apt to identify the four vertices of the trapezoid, the processing unit being further configured for filling said vector with two initial abscissa values and four initial ordinate values calculated by processing the obtained real reading curve, and, after the optimization procedure of the ideal curve, providing an optimized vector comprising optimized abscissa values and optimized ordinate values. For example, the optimized ordinate values can correspond to the blood (plasma) level in the tube and to the sedimentation level at the bottom of the tube, respectively, in particular when a certain sedimentation time has elapsed (and therefore after a certain time with respect to the first reference reading).

According to an aspect of the present invention, the processing unit can be configured for calculating the initial ordinate values as the maximum and the minimum of the reading curve, respectively, extreme measurement values being possibly discarded, calculating the initial abscissa values corresponding to the upper vertices of the trapezoid as the first and the last point of the reading curve equal to or lower than a certain threshold value, respectively, and allowing a prior definition of a difference of ordinate values and of a difference of abscissa values indicative of (that is, they are connected to) the increase/decrease (rise/fall) phase of the reading curve, and, based on this definition, calculating the initial abscissa values for calculating the lower vertices of the trapezoid as, respectively, the first points of the curve which satisfy the following expressions:

$${L}_{i} - {L}_{i + Δ Xs} > Δ {y}_{s}$$

$${L}_{i + Δ Xs} - {L}_{i} > Δ {y}_{s}$$

wherein the difference of ordinate values and the difference of abscissa values are parameters that are stored in a memory unit of the processing unit at default values and that can be modified to improve the optimization of the curve.

In an example, the processing unit can be further configured for calculating and/or detecting a specific point of the optimized theoretic curve and for using said point for the calculation of the ESR, wherein said reference point can be modified by modifying a suitable parameter, said point being for example on the oblique side of the trapezoid; the level of the plasma and sediment (ordinate) and the rate with which the sedimentation process occurs (e.g., by taking into account the oblique side) can be thus calculated.

According to an aspect of the present invention, the detection unit can comprise at least one emitter and a corresponding detector arranged so as to irradiate the tube and to collect the radiation after the same has passed through said tube.

According to an aspect of the present invention, the emitter can be a LED configured to essentially emit white light or infrared radiation, or in general any suitable wavelength.

According to an aspect of the present invention, the detection unit can be arranged on the moving means, which are configured to move the detection unit along the longitudinal axis of the tube, so as to allow the acquisition of a plurality of measurement points along said longitudinal axis.

According to an aspect of the present invention, the support of the tube can be comprised in a chain structure which is movable and defines a closed path for said tube, said chain structure comprising a plurality of supports for a corresponding plurality of tubes, said tubes being integrally movable with said chain structure.

According to an aspect of the present invention, the system can comprise four detection units arranged along the chain structure so that each of said four detection units is configured to analyze a tube, moved by the chain structure, at a corresponding time instant (that is at a different sedimentation time).

According to an aspect of the present invention, the system can further comprise a housing area for racks that are apt to contain tubes to be analyzed, and a gripper configured to pick up the tubes from the respective rack and to arrange them in the support on the chain structure.

According to an aspect of the present invention, the system can comprise an image detector configured to acquire images of the racks in the housing area, wherein the processing unit is configured to process the images acquired by said image detector, and to detect, based on said processing, the presence of the tubes and the position thereof in the racks, and to communicate this information to control means of the gripper, for example in order to ensure that the gripper moves directly into the position in which the tube to be picked up is present.

According to an aspect of the present invention, the agitating element can comprise guides in engagement with engaging elements (for example side portions) of the chain structure, which is structured in a plurality of portions that are connected to each other and are configured to rotate around an axis parallel to the direction of advancement of the tubes, said agitating element comprising movement means (for example motorized means/rotors coupled to a gear or belt/pully system) configured to move said guides and consequently to bring into rotation the portion of the chain structure engaged therewith.

The present invention also refers to a method for the measurement of the erythrocyte sedimentation rate in blood samples, comprising the steps of agitating a tube containing a blood sample to be analyzed, performing at least one optical measurement on the blood sample in the tube by means of at least one detection unit, said optical measurement involving the relative movement between the detection unit and the tube, so as to irradiate the tube in different portions, creating a reading curve corresponding to the absorption of radiation emitted by the detection unit as a function of the relative movement between the detection unit and the tube, based on said reading curve, defining an ideal curve of the trapezoidal type adapted to approximate the reading curve, carrying out a procedure of optimization of the ideal curve, thereby generating an optimized ideal curve, generating, based on said optimization procedure, at least one value indicative of the erythrocyte sedimentation rate of the blood sample contained in the tube, and outputting measurement results based on the generated values.

According to an aspect of the present invention, the optimization of the ideal curve can be carried out by least-squares minimization according to the Levenberg-Marquardt algorithm, wherein the minimized amount is calculated according to the following expression:

$${\sum }_{i} {( {L}_{i} - {T}_{i} )}^{2} / {W}_{i}$$

wherein Lᵢ represents the reading curve made up of a number of discrete points, Tᵢ represents the ideal curve made up of a number of discrete points (for example equal to the previous number), and wᵢ is a weight associated with each point.

According to an aspect of the present invention, the ideal curve of the trapezoidal type to be optimized can be defined by creating, according to a Cartesian reference system, a parameter vector comprising at least two ordinate values adapted to identify the two parallel bases of the trapezoid, at least four abscissa values adapted to identify the four vertices of the trapezoid, wherein the method can comprise the step of filling said vector with two initial abscissa values and the four initial ordinate values calculated by processing the obtained real reading curve, and after the procedure of optimization of the ideal curve, providing an optimized vector comprising optimized abscissa values and optimized ordinate values. The optimized ordinate values can correspond to the blood level (that is the plasma level) in the tube and to the level of sedimentation at the bottom of the tube, respectively.

The present invention also refers to a computer program product for the measurement of the erythrocyte sedimentation rate in blood samples, said computer program product comprising code portions apt to execute the method illustrated above.

The features and advantages of the system and of the method according to the invention will become apparent from the description, made hereinafter, of an embodiment thereof given by way of a non-limiting example with reference to the attached drawings.

### BRIEF DESCRIPTION OF THE DRAWINGS

In said drawings:

FIG. 1 is a general scheme of a system for the measurement of the erythrocyte sedimentation rate according to the present invention;

FIG. 2 is a perspective view of an optical detection unit according to an embodiment of the present invention;

FIG. 3 is a top view of the system according to an embodiment of the present invention;

FIG. 4 is a perspective view of a tube agitating element according to an embodiment of the present invention;

FIG. 5 is a perspective view of a tube gripper and a movement system thereof according to an embodiment of the present invention;

FIG. 6 shows examples of reading curves obtained with the system of the present invention; and

FIG. 7 is an example of theoretic curve of the trapezoidal type apt to approximate a real reading curve;

FIG. 8 is an exemplifying graph illustrating a definition of parameters of the theoretic curve of the trapezoidal type starting from the real reading curve;

FIG. 9 shows an example of theoretic curve of the trapezoidal type superimposed to a real reading curve obtained by an optical absorption measurement;

FIG. 10 shows the curves of the FIG. 9 with the errors to be minimized by a minimization procedure being highlighted; and

FIGS. 11A and 11B show the effect of the choice of a weight value in the optimization procedure of the theoretic curve of the trapezoidal type.

### DETAILED DESCRIPTION

Referring to said figures, 1 globally and schematically indicates a system for the measurement of the erythrocyte sedimentation rate in blood samples according to the present invention, said system operating according to a related method.

It should be noted that the figures represent schematic views and are not always drawn to scale, but are instead drawn so as to emphasize the important features of the invention. Further, in the figures, the various elements are represented in a schematic way and their shape can vary according to the desired application. It should be also noted that, in the figures, identical reference numbers refer to elements that are identical in shape or function. Finally, particular features described in relation to an embodiment illustrated in a figure can be used also for the other embodiments illustrated in the other figures.

It should also be noted that, unless explicitly indicated, the described process steps can also be reversed, if necessary.

The present invention provides a system and a method for the measurement of the erythrocyte sedimentation rate (ESR) in blood samples in a tube, identified with the reference P, which is not limited to a particular type. The tube P can indeed also be a normal blood count tube, but it should however be observed that the inventive aspects described herein are not limited to the aforementioned type of tube. In its most general aspect, the present invention is able to provide, in a very precise manner, the estimate of the ESR by means of an innovative analysis procedure of the collected data, thereby calculating parameters of interest and also providing an estimate of the effectiveness of the performed measurement, through an innovative analysis of the kinetics of the process. The following description therefore illustrates the fundamental steps for defining the system 1 and the related method which is object of the present invention.

In order to allow carrying out the operations described below, the system 1 comprises a processing unit (identified with the reference C), which includes specific memory units MEM and which is suitably programmed and designated for the management thereof, for the automatic control and for the analysis of measurement data. The processing unit C can be for example a computerized unit integrated in or external to the system and operatively connected thereto. Furthermore, it should be noted that the processing unit C can be a single unit or can comprise a plurality of local and/or remote units, possibly communicating with each other and each one of them being designated for carrying out specific operations. The processing unit C is therefore able to control the system 1 for obtaining the desired analysis of the blood samples. Anyway, the present invention is in no way limited to the architecture used for the control unit C, which can generally be any suitable computerized unit, comprising one or more units according to the needs and/or circumstances.

It should be also noted that the term “system 1” refers to a generic analysis apparatus, provided with a suitable case and containing a plurality of components cooperating with each other in order to obtain the desired calculation procedure, said apparatus not being anyway limited to a particular type.

Anyway, the present invention will be illustrated below with reference to a specific example wherein the tubes P containing the samples to be analyzed are moved by a chain system along various reading stations, even if, as mentioned above, the teachings described herein are not limited to this embodiment and are also applicable to many other types of apparatuses having a different configuration.

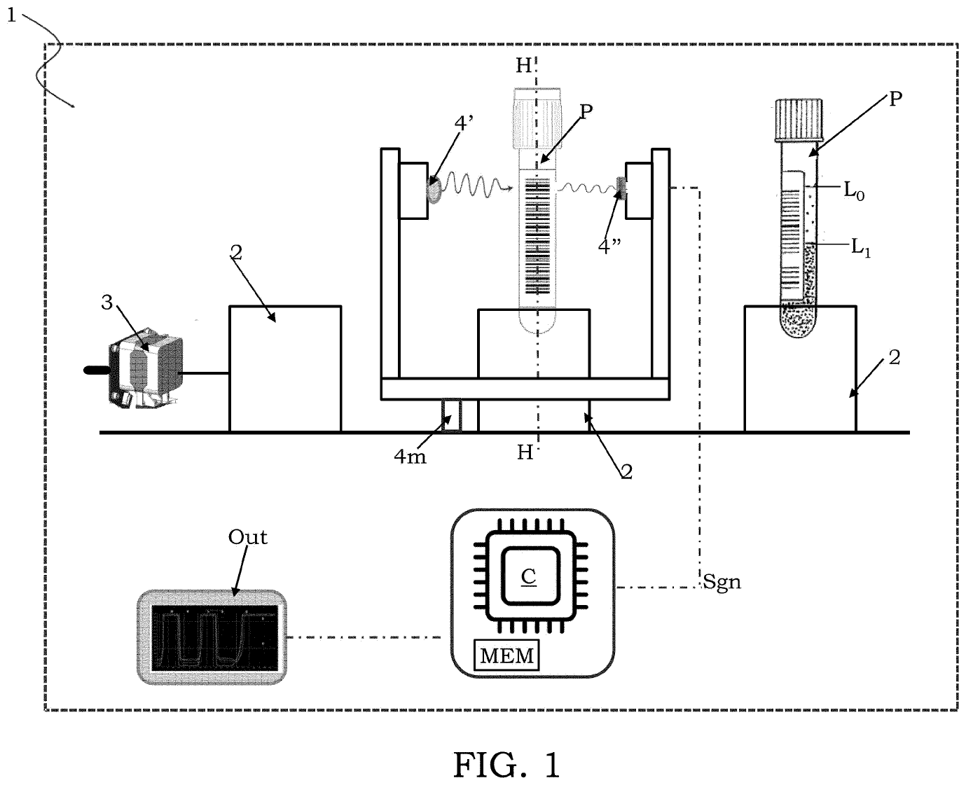

Referring to FIG. 1, the system 1, in its most general form, comprises a support 2 for housing at least one tube P containing a blood sample to be analyzed. In particular, the system 1 comprises a plurality of supports 2 for housing a corresponding plurality of tubes 2.

The system 1 furthermore comprises an agitating element 3 configured to agitate the tube P and to therefore allow the subsequent evaluation of the sedimentation process. The agitating element 3 is not limited to a particular configuration and substantially depends on the type of support used for housing and possibly moving the tubes. An example will be illustrated later on, in which the agitating element 3 cooperates with a movable chain structure on which the tubes P are arranged, without however limiting the scope of protection to said configuration; it should indeed be observed that, when the tubes are arranged on other types of supports, such as for example circular plates, the agitating means are obviously different and adapted to the specific case.

There is then at least one optical detection unit (identified with the reference 4 and also called hereinafter reading unit) configured to perform optical measurements, in particular optical absorption measurements, on the blood sample contained in the tube P.

In particular, the detection unit 4 comprises at least one emitter 4′ and a related detector 4″ arranged so as to irradiate the tube P with electromagnetic radiation and to collect the radiation after it has crossed said tube P. The emitter 4′ is preferably a LED configured to substantially emit white light, such that the presence of labels on the tube P (and other external factors) does not affect the measurement. Obviously, the emitter 4′ can emit radiation of any suitable wavelength, without being limited to particular values.

The detection unit 4 therefore allows, through absorption measurements on the blood sample in the tube P, to obtain reading curves which will be used as starting point of the calculation procedure of the present invention, as will be detailed hereinafter.

Suitable moving means 4m configured to cause a relative movement between the detection unit 4 and the tube P during the optical absorption measurement are further provided so as to irradiate said tube P in different portions, and therefore so as to obtain a plurality of n discrete measurement points (identified here and below with the subscript i, in particular the single point of the reading curve is identified as i-^{th} point) forming the reading curves. In particular, the moving means 4m are configured to cause a step movement of the detection unit 4. As will be detailed hereinafter, the obtained reading curves are representative of the light intensity detected as a function of the reading steps (said steps being possibly convertible in time instants).

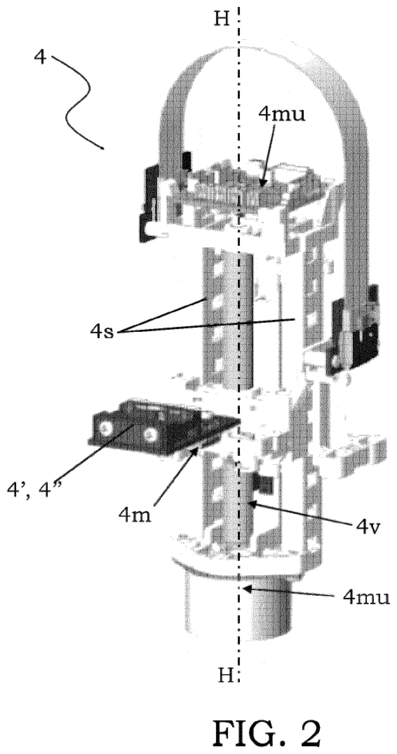

As illustrated in FIG. 2, which shows a non-limiting example of the reading unit 4, the moving means 4m can comprise a trolley moved by a suitable motor unit 4mu (comprising an own control driver board, which is also identified with the reference 4mu). The detection unit 4 (in particular both the emitter 4′ and the detector 4″) is therefore arranged on the trolley 4m, thus allowing a movement thereof in a direction which is substantially parallel to the longitudinal axis H-H of the tube P, and therefore allowing the acquisition of the plurality of measurement points along said longitudinal axis H-H. In this example, the motor unit 4mu moves an endless screw 4v, which in turn causes the movement of the trolley 4m. Further, in the example of FIG. 2, the emitter 4′ and the detector 4″ are both moved by the trolley 4m, said trolley being suitably shaped to allow the housing of the tube (not illustrated in FIG. 2) in a substantially central position thereof. All the aforementioned components are supported by a support 4s, which therefore acts as load-bearing structure of the detection unit 4.

It should however be noted that the present invention is in no way limited to the configuration of the detection unit 4, and therefore it is possible to adopt any other suitable configuration, for example in relation to the movement of the detectors/emitters or their arrangement. Any suitable structure for the detection unit (and therefore any emitter/detector assembly) therefore falls in the scope of the present invention.

In an embodiment of the present invention, when more than one reading unit is present, it is possible to carry out the related calibration (alignment) between the various reading units by adjusting the positioning of the emitter/detector with respect to a testing tube (not illustrated in the figures), acting on adjustment means so as to adapt the reading curves, in particular the detected light intensity, with respect to the references provided by said testing tube.

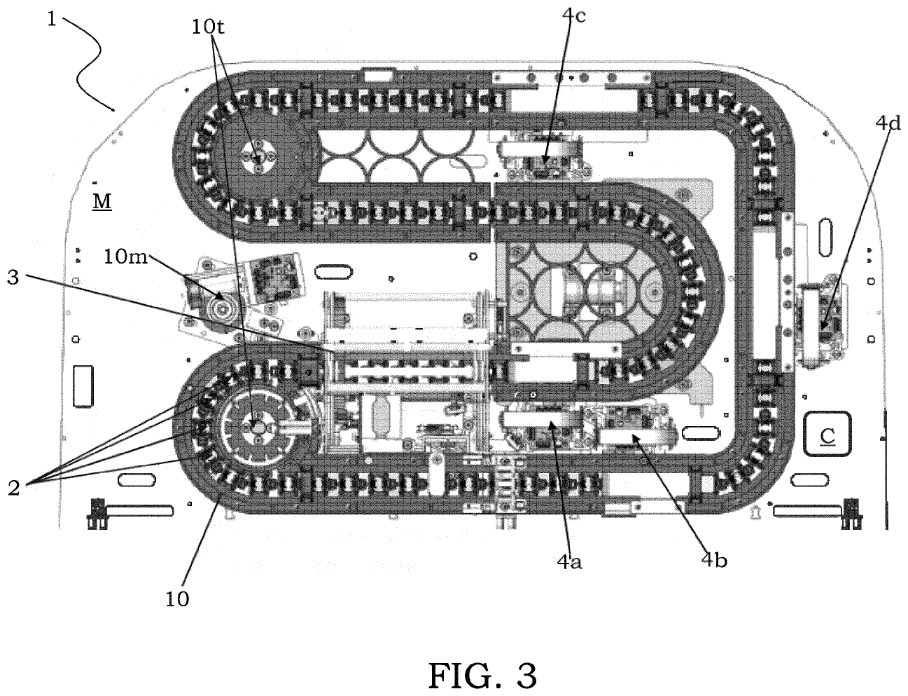

Referring now to FIG. 3, in a particular embodiment of the present invention, as previously mentioned, the system 1 comprises a chain structure 10 on which the supports 2 for the tubes P are formed. The chain structure 10 is movable and defines a closed path for the tubes P, said closed path substantially laying on a horizontal plane, for example parallel to the surface on which the system 1 is arranged.

The chain structure 10 comprises a plurality of portions connected to each other, each portion providing a support for at least one respective tube P. In an embodiment, the chain portions 10 are connected to each other by a ball joint and can rotate with respect to each other.

Thereby, the supports 2 for the tubes P are included in the chain structure 10 which is movable and defines the closed analysis path of said tubes P, said chain structure 10 comprising a plurality of supports for a corresponding plurality of tubes P, which are therefore integrally movable therewith.

In a particular embodiment, the system 1 comprises at least two detection units, preferably four detection units, arranged along the chain structure 10, such that each one of said four detection units is configured to analyze a tube P moved by the chain structure 10 in a specific time instant (that is at a specific sedimentation time).

In particular, a first detection unit 4a acquires a first reading curve soon after agitating the tubes (therefore carrying out a reference reading) while a second reading unit 4b, arranged in a different position along the chain 10, carries out a measurement after the tube P has passed through for a specific sedimentation time, for example after twenty minutes. Also other two detection units can optionally be present (for example the units 4c and 4d), arranged at intermediate points of the chain structure 10, so as to perform measurements also at intermediate time instants (for example at minutes twelve and seventeen).

To sum up, in the embodiment of FIG. 3, the analysis module M of the system 1 comprises the chain structure 10, which can have for example eighty-nine mashes in which the tubes P are inserted, said mashes being free to rotate in their junction point. The chain 10 rotates clockwise inside the analysis module by means of two traction wheels 10t moved by a motor unit 10m, transferring the tubes P to an agitating unit and subsequently to the optoelectronic units.

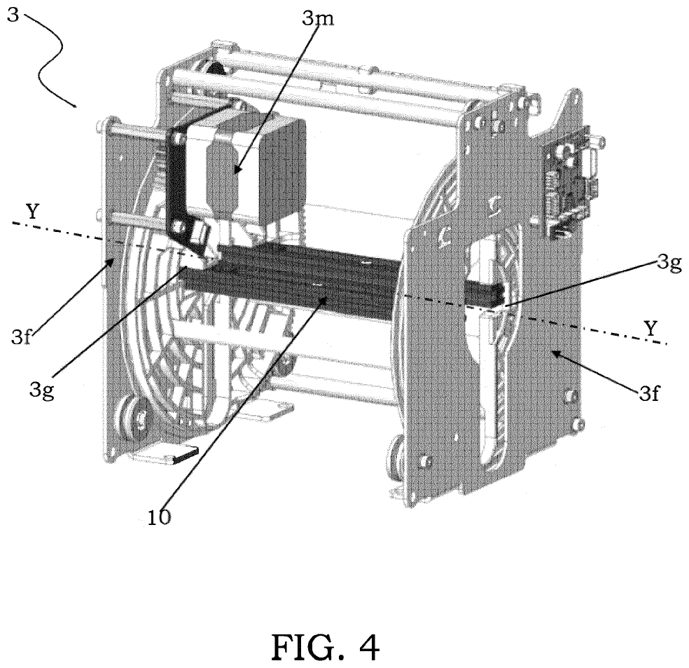

As mentioned, before carrying out the reading of the blood samples, the tubes are agitated by the agitating element 3. As illustrated in FIG. 4, the agitating element 3 can comprise guides 3g in engagement with engaging parts or elements (for example side tracks) of the chain structure 10, which—as seen above—is structured in various portions connected to each other and configured to rotate around an axis Y-Y parallel to the direction of advancement of the tubes P. Suitable motorized means 3m are furthermore present which means are configured to move said guides 3g through a suitable gear system (or also through a belt/pulley system) and consequently to bring into rotation the portion of the chain structure 10 engaged therewith. Essentially, a guide-pads system is therefore created which allows agitating the tubes P. As illustrated in the non-limiting example of FIG. 4, the guides 3g are formed into two flanges 3f, for example round-shaped, which integrally move by means of the motorized means 3m.

In certain alternative embodiments, the support 2 and the agitating means 3 can also be the same component which performs both functions, the present invention being indeed not limited to particular structural configurations of said components.

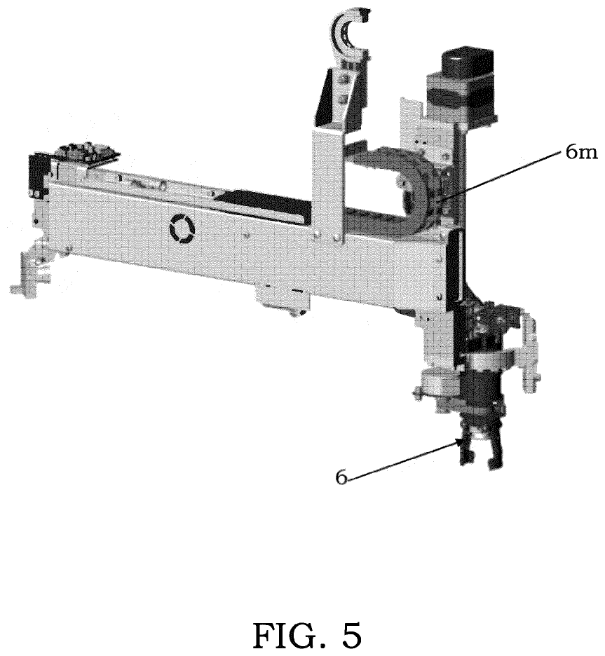

Referring now to FIG. 5, in some embodiments, the system 1 can also comprise a gripper 6 which is moved by suitable means 6m (controlled by suitable control means) and is configured to pick up the tubes P from a respective rack (not illustrated in the figures) and to arrange them in the support 2 on the chain structure 10.

A housing area for the racks containing the various tubes P to be analyzed can be also present, as well as control means can also be present (for example included in the processing unit C, also as separate unit) which are configured to verify the correct positioning of the various racks in said housing area. There is also an image detector (for example a photo/video camera) which acquires images of the racks and, after the processing of said images, the processing unit C is able to verify the presence of the tubes in the rack and the position thereof, so as to be able to communicate this information to the control means of the gripper 6.

Thereby, the gripper is moved exactly where the tube P is present in order to efficiently picking it up.

Anyway, as mentioned above, whatever the support and movement mode of the tubes P may be, the present invention envisages processing, through the processing unit C, the signals (identified with the reference Sgn) from the detection unit 4 which contain the information on the radiation absorption by the blood sample for creating and subsequently processing the reading curves.

In particular, based on said signals Sgn, the processing unit C is configured to firstly create the reading curve (identified with the reference L) corresponding to the real absorption of the radiation emitted by the detection unit 4. As mentioned above, the reading curve L comprises a plurality of n measurement points, acquired as a function of the relative movement between the detection unit 4 and the tube P, for example by the step movement of the motorized trolley 4m of FIG. 2.

As mentioned above, the reading curves L are acquired immediately after agitating the tubes and then after a specific sedimentation time (up to twenty minutes) and are therefore indicative of the sedimentation process in the tube.

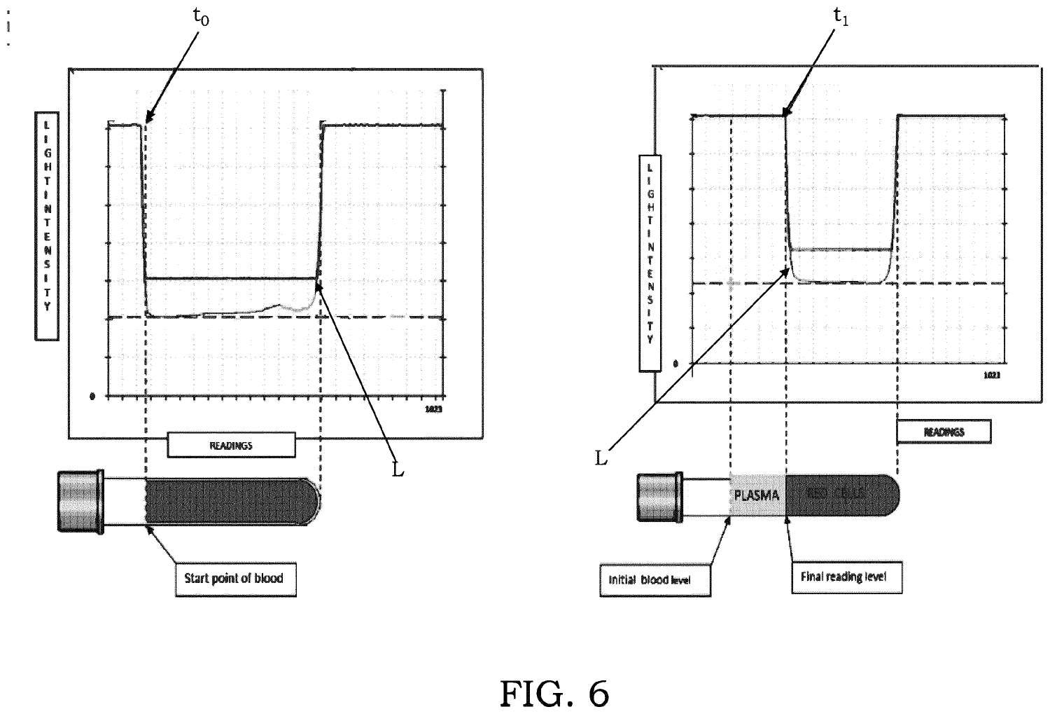

Due to the sedimentation process occurring after agitating the tubes P, the reading curve L shows, in the transition from plasma to sediment, a variation of the intensity of the measured radiation, in particular the absorption of radiation is higher at the sediment, thereby causing a decrease in the detected light intensity. There is then the presence of a (more or less constant) plateau up to the bottom of the tube, as illustrated in the examples of FIG. 6, which shows examples of reading curves L acquired through a detection unit 4 according to an embodiment of the present invention.

More in particular, as seen above, the reading curves L are acquired immediately after agitating the tubes (reference, left curve of FIG. 6) and then after a specific sedimentation time (up to twenty minutes, right curve of FIG. 6) so as to show information on the sedimentation process of the blood sample in the tube P through a comparison between them.

Even more in particular, in the reading subsequent to the reference one, that is the one occurring after a sedimentation time, it can be noted that the decrease in intensity due to the absorption of radiation occurs in a point t₁ subsequent to the point to in which the first reference reading occurs, due to the sediment which forms after a certain period of time (as illustrated in the example of FIG. 6, in which it can be seen that the plateau due to the absorption of the blood cells is displaced, due to the sedimentation, that is, after a certain period of time, the separation from the rest of the plasma, in which there is no significant absorption of radiation, has occurred), therefore providing useful information for estimating the erythrocyte sedimentation rate.

The control unit C therefore comprises processing means (for example suitable software modules) for processing the desired measurements according to predefined protocols, thereby allowing the analysis of the blood samples.

Based on this behavior of the reading curves L, studies made by the Applicant developed an innovative method for analyzing said curves, which method involves defining, based on said reading curve L, an ideal curve T of the trapezoidal type which suitably approximates the real behavior. The use of a trapezoidal curve is very useful since it is an excellent starting point for analyzing the acquired reading curves, due to the trend described above.

Obviously, the term “trapezoid” or “of the trapezoidal type” is to be understood in a broad way, it can indicate a whole trapezoid or only a portion thereof (for example comprising only one of the two oblique sides), therefore generally meaning a shape (trend) comprising two sides which are substantially parallel and at least one oblique side between them, according to a Cartesian reference system; in other words, the ideal curve of the trapezoidal type can be a function with two substantially constant portions with respect to the ordinate and at least one portion with a certain slope between them (in the following example, a case will be presented in which a trapezoidal function with both opposite oblique sides indicating the decrease and increase of the detected intensity is provided).

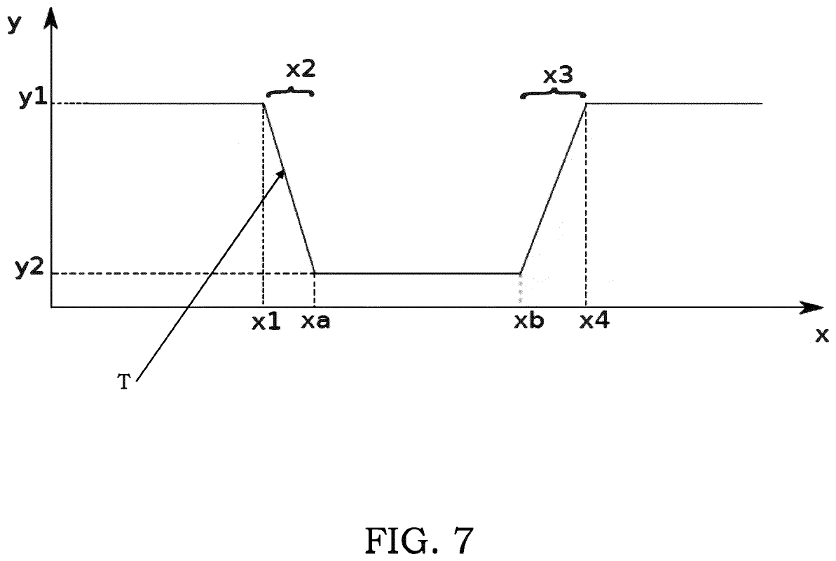

The calculation process of the present invention is therefore based on the approximation of the reading curve L with a function with trapezoidal trend T (schematically shown in FIG. 7), which represents the ideal trend of the curve.

In other words, once the reading curve L made up of n points (that is Lᵢ, with i=0, . . . , n−1) is experimentally obtained, the curve T is defined, also made up of n points (that is Tᵢ, with i=0, . . . , n−1). As already noted, the discretization of the measurement points is due to the steps of the trolley which moves the detection unit 4: each step corresponds to a measurement point.

The calculation process carried out by the processing unit C for determining the best approximation of the reading curve L is based on a least-squares optimization algorithm; the determination of an ideal approximated curve T is therefore provided, which is used as starting point of the optimization procedure, after which an excellent trapezoidal curve is produced (identified with the reference T′) which better represents the real reading curve L. Finally, the reading parameters are calculated using only said excellent trapezoidal curve T′, and not the original reading curve L.

The processing unit C therefore comprises a reading and analysis module of the reading curves L, apt to allow the execution of codes for analyzing said absorption curves through the aforementioned approximation and following optimization, outputting, for example, the identification of two fundamental values (also called deflection points) corresponding to the level of the blood sample and the related sediment deposited at the bottom of the tube P, as well as an estimate of the effectiveness of the performed measurement and analysis.

The rest of the present description will illustrate all the details of this procedure.

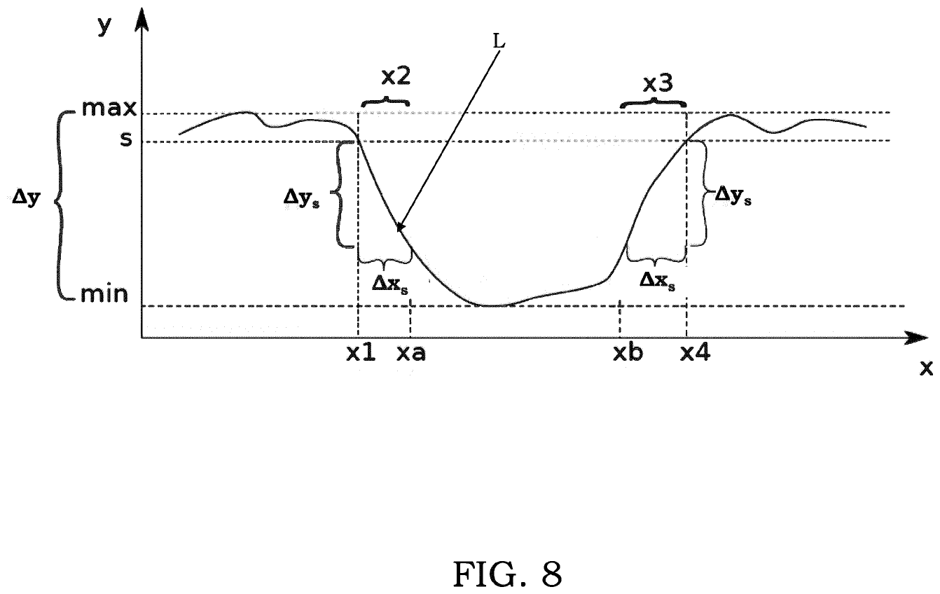

As indicated above, in this calculation procedure, the preliminary ideal trapezoidal curve T is firstly defined. More in particular, the processing unit C is configured to define the ideal curve T of the trapezoidal type to be optimized by creation, according to a Cartesian reference system x-y, of an initial parameter vector V comprising two ordinate values (called, in FIGS. 7 and 8, y₁ and y₂) apt to identify the two parallel bases of the trapezoid and four abscissa values (called x₁, x₂, x₃ and x₄) apt to identify the four vertices of the trapezoid.

In other words, six parameters are identified: the ordinates of the two horizontal portions and the abscises of the four vertices of the trapezoid. These parameters therefore form the vector V of six elements, that is V=(x₁, x₂, x₃, x₄, y₁, y₂), represented in FIG. 7. The parameters x₁ and x₄ therefore represent the coordinates of the utmost points of the ideal trapezoid, while the parameters x₂ and x₃ represent the length along the abscissa of the oblique sides of said trapezoid. The processing unit C is therefore programmed so as to fill the vector V with the aforementioned four abscissa values and the aforementioned two initial ordinate values, processing the real reading curve L obtained by the optical measurement of the blood samples in the tube P.

Even more in particular, in defining the theoretic curve T which initially approximates the real one, the ordinate initial values (that is y₁ and y₂) are respectively calculated as the minimum and the maximum of the reading curve L, possibly discarding extreme measurement values of said reading curve L in order to avoid artifacts at the beginning and at the end of the reading, in particular in the calculation of y₂. By way of example only, two parameters identified as “head” and “tail” can be defined, equal to 10 and 20, respectively, and the portion of the reading curve L which is obtained eliminating therefrom the first head and the last tail elements is considered. In formulas, there is: y₁=max(Lᵢ) for i between O and N, and y₂=min (Lᵢ), for i>tail and i<N-tail; it is then defined Δy=y₁−y₂, that is the width of the variation between maximum and minimum, as illustrated in FIG. 8, which is an exemplifying graph of the calculation of the initial values of the theoretic curve T starting from the reading curve L.

Further, the initial abscissa values (x₁, x₄), corresponding to the upper vertices of the trapezoid are respectively calculated as the first and the last point of the reading curve L equal to or lower than a certain threshold value s. Even more preferably, the point x₁ is found to be the first point of the curve L which falls below the threshold value given by s=y2+0.9*Δy. Analogously, the point x₄ is the last point of the curve which has a value lower than s.

To determine the points x₂ and x₃, two amounts are defined: a displacement along the abscises, Δxₛ, and a value along the ordinate (also called “slope”), Δyₛ. The decreasing portion is then identified in which the reading curve L decreases by the amount Δyₛ in a number of points comprised in the range Δxₛ. In the formulas, the first value of i is found (that is the i-th point) therefore it is so that Lᵢ-Lᵢ+Δxₛ>Δyₛ. The value of i found in this way, possibly increased of an arbitrary value (in a non-limiting example, said value is taken equal to 5), defines the point xₐ of FIG. 8, from which x₂=xₐ-x₁ is obtained. An analogous process is performed on the right side of the curve, thereby finding the last (that is the rightmost) value of i being so that Lᵢ+Δxₛ-Lᵢ>Δyₛ (the inversion of sign is due to the fact that, in this case, the curve is increasing), then defining x_{b}=i−8 (that is, analogously to what was made for the left part of the curve, the result is subtracted by a chosen arbitrary value equal to 8 but without being limiting thereto) and finally x₃=x₄-x_{b} is obtained.

In other words, to define the points x₂ and x₃, which are indicative of the lower vertices of the trapezoid, a difference of ordinate values (that is the slope Δyₛ) and a difference of abscissa values (that is the displacement Δxₛ) indicative of the increase/decrease phase (rise/fall) of the reading curve L are defined in advance, and, based on said definition, the abscissa values x₂ and x₃ are respectively calculated as the first points i of the curve which satisfy the expressions seen above, that is:

$${L}_{i} - {L}_{i +} Δ {x}_{s} > Δ {y}_{s}$$

$${L}_{i +} {Δ}_{Xs} - {L}_{i} > Δ {y}_{s}$$

The criterion for an optimal choice of the parameters Δxₛ and Δyₛ can be defined as follows: the ratio Δyₛ/Δxₛ represents the minimum slope of the necessary curve for identifying the decreasing or increasing portion of the same curve. A too high value of the ratio can therefore make it impossible to identify the slope, since no portion of the curve reaches the required slope. A too low value can instead lead to erroneously identify local oscillations that are present at the beginning or at the end of the same curve. Specifically, with respect to the value of Δxₛ, a too low value can lead to detecting the local noise effect on the curve, while a too high value requires (in order to have adequate values of the ratio Δyₛ/Δxₛ) a value of Δyₛ which cannot be reached in the range of variability of the curve. The value of Δyₛ is therefore determined by Δxₛ and the ratio.

The parameters Δyₛ and Δxₛ are stored in the memory unit MEM of the processing unit C with default values and can be possibly modified to improve the procedure. Anyway, it can be observed that, if said parameters are chosen within a quite wide specific range, they do not negatively affect the final result.

Also the parameters head and tail, used to discard the extremes of the reading curve L, are stored in the memory unit MEM with default values and they can also be adjusted based on the needs.

A control for verifying if the four points x₁, xₐ, x_{b}, x₄ are in an increasing order is then carried out. If this is not verified, the points xₐ and x_{b} are repositioned immediately to the left of x₁ and immediately to the right of x₄, respectively. If after said control, xₐ is still >x_{b}, both said points are repositioned in the midpoint between x₁ and x₄.

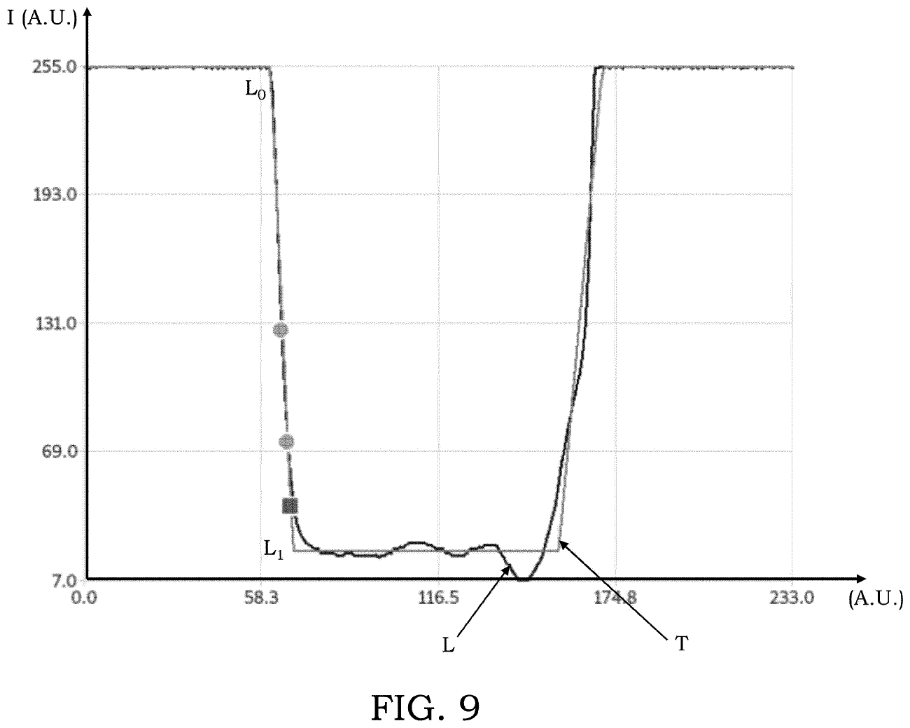

FIG. 9 illustrates the overlap between the starting theoretic curve T calculated as described above and the reading curve L. The ordinate values correspond to the variation of light intensity and the abscissa values correspond to the displacement of the LED, for example to the steps of the trolley 4m which displaces said LED; in particular, in this non-limiting example, the reading (and therefore also the related approximation curve) starts from a level of the tube in which there is no blood present (upper flat line), then the intensity decreases starting from the level L₀ with a specific slope down to a plateau which is more or less regular and indicates the absorption by the sediment which continues down to the bottom of the tube, rising then up again, as previously described.

Once the theoretic starting curve T is defined in the way indicated above, an optimization procedure of said theoretic curve is performed by the processing unit C, said optimization being based on a least-squares minimization, by adapting the ideal curve T to the real reading curve Las accurately as possible.

In particular, the aforementioned optimization firstly involves the definition of a cost functional Cs calculated as the weighted sum of the squares of the differences between the theoretic curve T and the reading curve L (from which some measurement points have possibly been excluded in advance, as indicated above). The cost functional to be minimized is calculated by the following expression:

$$Cs = {\sum }_{i} {( {L}_{i} - {T}_{i} )}^{2} / {W}_{i}$$

wherein wᵢ is a weight associated with each point of the curves Lᵢ and Tᵢ.

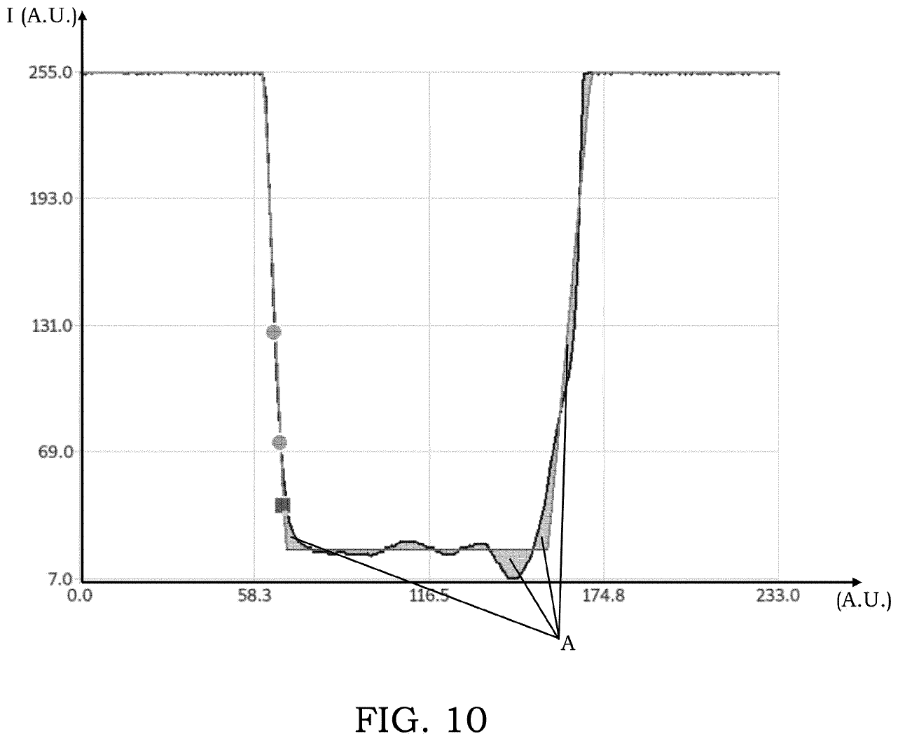

The cost functional Cs is connected to the area A comprised between the curve T and the curve L, highlighted in FIG. 10.

From a mathematical point of view, the measurement of the area A would in fact be equal to A=iΣᵢ|Lᵢ−Tᵢ|. However, the minimization of a functional cost containing an absolute value has numerical problems and therefore it is preferred to minimize a quadratic cost functional, represented by the expression above. The addition of the weight wᵢ furthermore allows to weight the areas of the curve in a different way, according to the needs.

In particular, the weight wᵢ associated with each one of the elements of the summation is defined based on the width of the curve, scaled to a value comprised between zero and one. Even more particularly, the weight wᵢ is calculated based on the following expression:

$${w}_{i} = {p}_{2} + ( 1 - {p}_{2} ) * ( {L}_{i} - {y}_{2} ) / ( {y}_{1} - {y}_{2} ) + ε$$

wherein p₂ is a parameter apt to define the weight of the single points i of the reading curve L, and ε is an optional correction factor to which the value 10⁻⁹ is assigned in order to avoid dividing by zero (which can occur when Lᵢ=y₂ and p₂=0) in the definition of the cost Cs.

As for the other variable parameters seen above, p₂ is also a parameter stored in the memory unit MEM of the processing unit C with a default value and it can be modified to improve the optimization of the curve. According to an embodiment of the present invention, the cost functional Cs is minimized through the Levenberg-Marquardt algorithm, thereby obtaining the optimal value of the vector V seen above (that is the optimized vector V′ is obtained) and therefore providing an optimized trapezoidal theoretic curve, indicated as T′.

In other words, the processing unit C is configured to perform the optimization of the starting trapezoidal curve, for example based on the Levenberg-Marquardt procedure, in order to provide the optimized theoretic curve T′ and to therefore obtain the desired optimized parameters V′=(x₁′, x₂′, x₃′, x₄′, y₁′, y₂′).

It can furthermore be noted that, based on the aforementioned definition of the weight wᵢ, when p₂ is equal to 1, wᵢ=1 is obtained, that is all the errors are weighted in the same way, while, with values of p₂ lower than one, the smaller values of the curve are considered to be more important in the minimization procedure (wᵢ<1, therefore 1/wᵢ>1). When Lᵢ has a value near to the upper limit, there is Lᵢ=y1, and therefore wᵢ=1.

In general, the value of p₂, comprised between 0 and 1, is determined based on the relative importance that one wants to give to the error in the lower part and in the upper part of the curve; by varying the parameter p₂, a deformation of the oblique sides of the trapezoid can indeed be observed, especially if the curve is irregular (with slope variations along the decreasing or increasing portion). In this case, the oblique side tries to follow one or the other of the two slopes based on the same parameter. As mentioned above, for very low values of p₂, the optimized theoretic curve gets near to the lower side of the curve L, ignoring the upper part, while, for values closer to 1, the trapezoid follows the reading curve L also in the upper part.

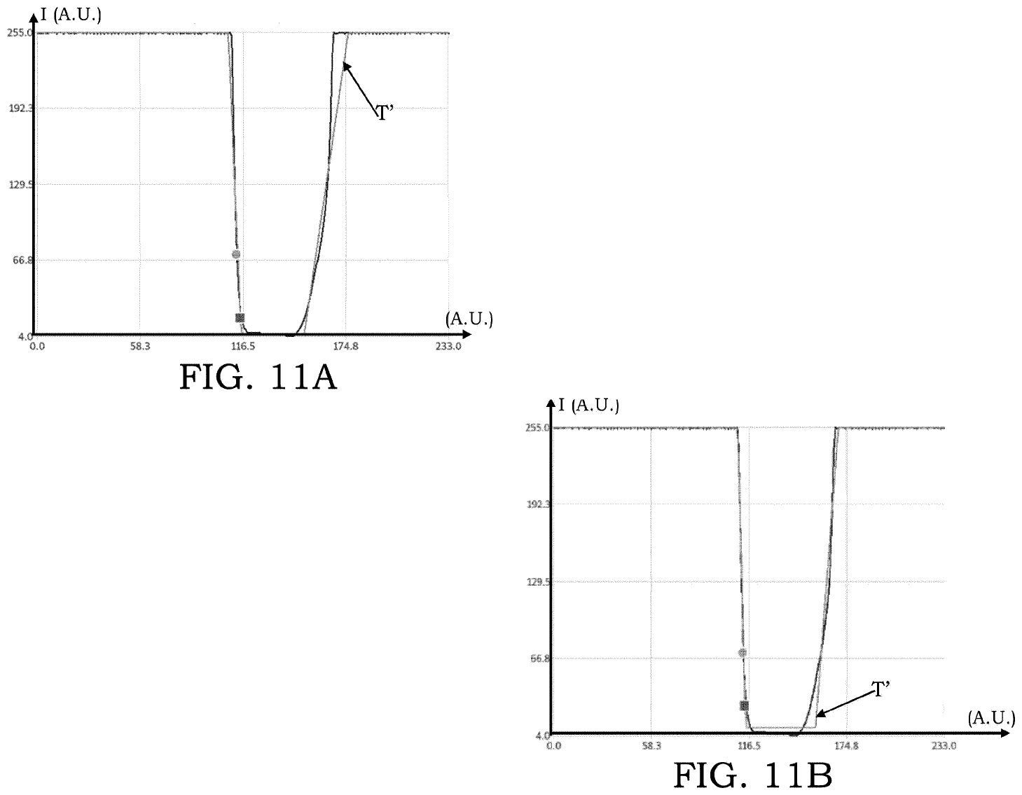

FIGS. 11A and 11B show an example of the behavior of the system in a case in which the curve, on the right side, has a slope variation. It should be noted how, for small values of p₂, the optimized theoretic curve T′ follows the area in the lower region of the graph with high precision, moving away from the reading curve L when the latter gets close to its maximum. Conversely, with a value of p₂ equal to one, the errors are all weighted in the same way, therefore, the trapezoid follows the average slope detected in the increasing portion.

According to the present invention, the estimate of the output values is made starting from the calculated trapezoidal function. Based on the behavior of the curves, it is envisaged to obtain the output values (that is the values for calculating the ESR) based on the oblique side of the trapezoid, that is based on the decrease of the curve, decrease which, as seen, after a certain sedimentation time, occurs in a different moment than in the reference curve.

In detail, the point lying on the first oblique side of the trapezoid, at the ordinate yₒ corresponding to the value yₒ=y₁−Δ_{y}*p₁ is calculated. The corresponding value of x, called xₒ, is the output value of the procedure. The value of p₁ therefore allows to choose the level of the point, which is variable between the upper vertex (when p₁=0) and the lower vertex (when p₁=1) of the oblique side of the trapezoid. In FIGS. 9 and 10, the two dots indicate the output values corresponding to values of p₁ equal to 0.6 and 0.8, while the square indicates the value determined for p₁=0.9. It can be observed how the points are located on the descending side of the trapezoid T (and not on the curve L). In other words, the parameter p₁ is used to position the reference point in the most suitable point of the oblique side.

In other words, the parameter p₁ represents a percentage on the travel in y of the curve (oblique side of the trapezoid) in which the blood level is detected and it allows to displace the point defining the “result”. The output value of the algorithm (connected to the ESR) therefore corresponds to the coordinate x of a point comprised between the extremes of the oblique layer. When p₁=0, the output corresponds to an extreme, when p₁=1, the output corresponds to the other extreme. From a practical point of view, this parameter allows to calibrate the calculation as needed so as to obtain values which can be compared with other values. Since the reading curve L is generally more rounded than the trapezoid (see FIG. 10), considering the lower vertex of the oblique layer as output value would cause a small error and, for this reason, the parameter p₁ has been introduced, which takes into account the presence of the area A.

In an embodiment of the present invention, the processing unit C is therefore further configured to provide an estimate of the quality of the performed measurement, for example based on comparisons with a reference.

To sum up, after the optimization procedure of the ideal curve T, an optimized vector V′ is output which comprises the two ordinate values and the four optimized abscissa values, wherein the optimized ordinate values (y₁′, y₂′) respectively correspond to the blood level L₀ in the tube P and to the sedimentation level L₁: the determination of these two amounts allows to determine, through known correlations, the ESR, or, in general, values of interest.

It is therefore possible to generate, based on said procedure, indicative values of the erythrocyte sedimentation rate of the blood sample contained in the tube P. In other words, the present invention allows to obtain, by the aforementioned procedure of fitting with curves which suitably approximate the real absorption curves, the fundamental parameters that are connected to the sedimentation process, in order to estimate the ESR in a very precise manner; the calculated values, as mentioned, can then be processed by known correlations to obtain the ESR.

In an embodiment of the present invention, the system 1 further comprises output means (indicated with the reference Out) configured to output the measurement results based on said generated values. It should be noted that the present invention is not limited to particular output means, which can comprise any suitable means, from a display (for example a touchscreen display) which displays the measurement results of the measurement to a printer which generates a paper report. For example, the calculated ESR or values connected thereto can be displayed.

In light of the above, it is apparent that the present invention also relates to a method for the measurement of the erythrocyte sedimentation rate in blood samples, said method comprising all the aforementioned steps of the calculation procedure, as well as a computer program product for the measurement of the erythrocyte sedimentation rate in blood samples, said computer program product comprising code portions apt to carry out the aforementioned method.

To conclude, the present invention therefore allows to brilliantly overcome the technical problem, providing the system and method as above and solving all the drawbacks of the prior art.

Advantageously, the experimental results obtained by optical absorption measurements by the blood samples are processed in an innovative and efficient way, providing a highly precise diagnostic tool and method for estimating the ESR.

In order to implement the calculation procedure of the present invention, it is sufficient to provide the processing unit with a limited number of parameters, which refer to the initial estimate of the theoretic curve (that is the definition of the extremes and the slope of the reading curve), to the optimization procedure (that is the weight associated with each point of the curve), and to the location of the reference point on the theoretic curve. Said parameters are set in the system memory with default values but can be modified based on specific needs.

All the technical results described herein are obtained by a simple experimental system and with a quick measurement (both from the point of view of analysis time—in which the last reading occurs after around twenty minutes—and from the point of view of calculation time), in which the measurement errors are extremely reduced, if not completely eliminated.

The calculation procedure of the present invention is indeed extremely advantageous and the comparison with the Westergreen standard method indicates a very high correlation (for example, the Pearson and Spearman correlation coefficients are respectively equal to r=0.909 r=0.914), thereby demonstrating the effectiveness of the described solution.

Obviously, a person skilled in the art, in order to satisfy contingent and specific needs, can make various modifications and variations to the system and method described above, which modifications and variations are all included in the scope of protection of the invention as defined by the following claims.

1. A system for the measurement of the erythrocyte sedimentation rate in blood samples, comprising:
a support for a tube which is adapted to contain a blood sample to be analyzed;
an agitating element configured to agitate the tube;
a detection unit configured to perform a optical measurement on the blood sample in the tube;
moving means configured to cause a relative movement between the detection unit and the tube during the optical measurement; and
a processing unit adapted to process signals from the detection unit, wherein, based on said signals, said processing unit is configured to:
create a reading curve corresponding to the absorption of radiation emitted by the detection unit as a function of the relative movement between said detection unit and the tube;
based on said reading curve, define an ideal curve of the trapezoidal type adapted to approximate said reading curve;
perform a procedure of optimization of said ideal curve, thereby generating an optimized ideal curve; and
generate, based on said optimization procedure, at least one value indicative of the erythrocyte sedimentation rate of the blood sample in the tube,
said system further comprising output means configured to output measurement results based on said generated values.

2. The system according to claim 1, wherein the processing unit is configured to carry out the optimization of the ideal curve by means of least-squares minimization.

3. The system according to claim 2, wherein the processing unit is configured to carry out the optimization procedure according to the Levenberg-Marquardt algorithm, wherein the minimized amount is calculated according to the following expression:
$$\text{?} {( \text{?} - \text{?} )}^{2} / \text{?}$$
$$\text{?} \text{indicates text missing or illegible when filed}$$
wherein Lᵢ represents the reading curve which comprises a number of discrete points, Tᵢ represents the ideal curve which comprises a number of discrete points, and wᵢ is a weight associated with each point.

4. The system according to claim 3, wherein the weight wᵢ is calculated according to the following expression:
$${w}_{i} = {p}_{2} + ( 1 - {p}_{2} ) * ( {L}_{i} - {y}_{2} ) / ( {y}_{1} - {y}_{2} ) + ε$$
wherein p₂ is a parameter adapted to define the weight of the single points of the reading curve, and ε is a corrective factor, and
wherein p₂ is a parameter stored in a memory unit of the processing unit at a default value and is apt to be modified to improve the optimization of the curve.

5. The system according to claim 1, wherein the processing unit is configured to define the ideal curve of the trapezoidal type to be optimized by creation, according to a Cartesian reference system, of a parameter vector comprising:
at least two ordinate values apt to identify the two parallel bases of the trapezoid; and
at least four abscissa values apt to identify the four vertices of the trapezoid, said processing unit being further configured to:
fill said vector with two initial abscissa values and four initial ordinate values calculated by processing the obtained reading curve; and
after the optimization procedure of the ideal curve, provide an optimized vector comprising optimized abscissa values and optimized ordinate values, wherein the optimized ordinate values correspond to the plasma level in the tube and to the sedimentation level in said tube, respectively.

6. The system according to claim 5, wherein the processing unit is configured to:
calculate the initial ordinate values as the maximum and the minimum of the reading curve, respectively, possibly discarding extreme measurement values;
calculate the initial abscissa values corresponding to the upper vertices of the trapezoid as the first and the last point of the reading curve equal to or lower than a certain threshold value, respectively; and
allow a definition of a difference of ordinate values Δyₛ and of a difference of abscissa values Δxₛ relating to the rise/fall phase of the reading curve, and, based on said definition, calculate the initial abscissa values for calculating the lower vertices of the trapezoid as, respectively, the first points of the curve which satisfy the following expressions:
$${L}_{i} - {L}_{i + Δ Xs} > Δ {y}_{s}$$
$${L}_{i + Δ Xs} - {L}_{i} > Δ {y}_{s}$$
wherein the difference of ordinate values Δyₛ and the difference of abscissa values Δxₛ are parameters stored in a memory unit (MEM) of the processing unit at default values and are apt to be modified to improve the optimization of the curve, and wherein Lᵢ represents the reading curve which comprises a number of discrete points.

7. The system according to claim 1, wherein the detection unit comprises at least one emitter and a corresponding detector arranged so as to irradiate the tube and to collect the radiation after the same has passed through said tube, wherein said emitter is a LED configured to emit substantially white light or infrared radiation.

8. The system according to claim 1, wherein the detection unit is arranged on the moving means, which are configured to move said detection unit along a longitudinal axis of the tube, so as to allow the acquisition of a plurality of measurement points along said longitudinal axis.

9. The system according to claim 1, wherein the support of the tube is comprised in a chain structure which is movable and defines a closed path for said tube, said chain structure comprising a plurality of supports for a corresponding plurality of tubes, said tubes being integrally movable with said chain structure.

10. The system according to claim 9, comprising four detection units arranged along the chain structure so that each of said four detection units is configured to analyze a tube, moved by the chain structure, at a corresponding time instant.

11. The system according to claim 9, further comprising:
a housing area for racks, each rack being apt to contain tubes to be analyzed;
a gripper configured to pick up the tubes from the respective rack and to arrange them in the support on the chain structure; and
an image detector configured to acquire images of the racks in the housing area, wherein the processing unit is configured to process the images acquired by the image detector, and to detect, based on said processing, the presence of the tubes and the positions thereof in the racks, and to communicate this information to control means of the gripper.

12. The system according to claim 9, wherein the agitating element comprises guides in engagement with engaging elements of the chain structure, which is structured in a plurality of portions that are connected to each other and are configured to rotate around an axis parallel to a direction of advancement of the tubes (P), said agitating element comprising movement means configured to move said guides and consequently to bring into rotation the portion of the chain structure engaged therewith.

13. A method for the measurement of the erythrocyte sedimentation rate in blood samples, comprising:
agitating a tube containing a blood sample to be analyzed;
performing an optical measurement on the blood sample in the tube by means of a detection unit, said optical measurement involving the relative movement between the detection unit and the tube;
creating a reading curve corresponding to the absorption of the radiation emitted by the detection unit as a function of the relative movement between the detection unit and the tube;
based on said reading curve, defining an ideal curve of the trapezoidal type adapted to approximate the reading curve;
carrying out a procedure of optimization of the ideal curve, thereby generating an optimized ideal curve;
generating, based on said optimization procedure, a value indicative of the erythrocyte sedimentation rate of the blood sample contained in the tube, and
outputting measurement results based on said generated values.

14. The method according to claim 13, wherein the optimization of the ideal curve is carried out by least-squares minimization according to the Levenberg-Marquardt algorithm, wherein the minimized amount is calculated according to the following expression:
$$\text{?} {( \text{?} - \text{?} )}^{2} / \text{?}$$
$$\text{?} \text{indicates text missing or illegible when filed}$$
wherein Lᵢ represents the reading curve comprising a number of discrete points, Tᵢ represents the ideal curve comprising a number of discrete points, and wᵢ is a weight associated with each point.

15. The method according to claim 13, wherein the ideal curve of the trapezoidal type to be optimized is defined by creation, according to a Cartesian reference system, of a parameter vector comprising:
at least two ordinate values adapted to identify the two parallel bases of the trapezoid; and
at least four abscissa values adapted to identify the four vertices of the trapezoid, the method comprising:
filling said vector with two initial abscissa values and four initial ordinate values calculated by processing the reading curve (L) obtained; and
after the procedure of optimization of the ideal curve, providing an optimized vector comprising optimized abscissa values and optimized ordinate values, wherein the optimized ordinate values correspond to the plasma level in the tube and to the level of sedimentation in the tube, respectively.

16. (canceled)
